(19) United States
(12) Patent Application Publication
(10) Pub. No.: US 2020/0388482 A1
(43) Pub. Date: Dec. 10, 2020

(54) ELECTRODELESS PLASMA LAMP

(71) Applicant: Topanga Asia Limited, KOWLOON (HK)

(72) Inventors: Wing Yiu LAM, NEW TERRITORIES (HK); Yuen Fat LEE, KOWLOON (HK); Eddie Koon Chung LAU, North Point (HK)

(73) Assignee: Topanga Asia Limited, KOWLOON (HK)

(21) Appl. No.: 16/894,109

(22) Filed: Jun. 5, 2020

(30) Foreign Application Priority Data
Jun. 5, 2019 (HK) 19124785.7

(51) Int. Cl. H01J 65/04; H01J 61/04

(52) U.S. Cl. CPC H01J 65/042; H01J 61/04

(57) ABSTRACT

There is provided an electrodeless plasma lamp and confinement member for an electrodeless plasma lamp. The lamp comprises a lamp body with an input coupling element, with one end coupled to an RF source and the other end coupled to a first ground potential. An output coupling element is received substantially within the lamp body and spaced apart from the input coupling element and from the top of the lamp body, wherein one end of the output coupling element is coupled to a second ground potential and the other end of the output coupling element at the top of the lamp body is coupled to a gas filled vessel. An electromagnetic confinement member extends away from the lamp body and surrounds it for reducing emission of electromagnetic waves below a predetermined threshold frequency, and includes a plurality of apertures formed therein.

### FIELD

The present disclosure is directed to electrodeless plasma lamp, especially an electrodeless lamp with high intensity discharge.

### BACKGROUND

Plasma lamps provide extremely bright, broad spectrum light, and are useful in many applications, especially to provide general illumination of large areas including stadiums, parking lots etc; as well as in high ceiling areas such as industrial buildings where the light source is separated a long way from where it is needed.

In traditional plasma lamps, plasma is generated from a mixture of gas and trace substances by using a high current passed between closely-contacting electrodes. However, the electrodes of these types of plasma lamps typically deteriorate during prolonged use and therefore have a limited lifetime.

Electrodeless plasma lamps have also been developed, with light energy generated by coupling radio frequency (RF) energy from an RF driver or source to a gas-filled vessel (bulb). Typically the RF source is connected to one end of an input coupling element, the other end of the input coupling element being connected to ground. RF energy is coupled from the input coupling element to the output element and to a gas filled vessel (bulb) supported on one end of the output element. (The other end of the output coupling element is usually connected to ground). The input element may be separated from the output coupling element by a space or gap (which may filled with dielectric or may simply be air). The bulb may be received mostly, partially or not at all within the lamp body depending on desired configuration.

However, in such arrangements electromagnetic compatibility (EMC) issues caused by residual electric field leaking around the bulb and to the surrounding area remain problematic and impede widespread usage of such devices.

### SUMMARY OF THE INVENTION

According to an aspect of the disclosure, there is an electrodeless plasma lamp comprising: a lamp body having an input coupling element received therein, wherein one end of the input coupling element is coupled to an RF source and the other end is coupled to a first ground potential; an output coupling element received substantially within the lamp body and spaced apart from the input coupling element and from the top of the lamp body, wherein one end of the output coupling element is coupled to a second ground potential and the other end of the output at the top of the lamp body is coupled to a gas filled vessel; an electromagnetic confinement member configured to extend away from the lamp body and surround the end of the output coupling element proximal to the gas filled vessel for reducing emission of electromagnetic waves below a predetermined threshold frequency therefrom, said electromagnetic confinement member including a plurality of apertures formed therein.

Dimensions of the electromagnetic confinement member including at least one or more of cross sectional shape and cross sectional dimensions may be configured according to the predetermined threshold frequency or waveguide theory.

The distance the electromagnetic confinement member extends away from the lamp body may be determined by selecting an asymptotic value of shielding performance of a plurality of distances of the confinement member of the lamp relative to a lossless ideal shielding element at the same plurality of distances.

The electromagnetic confinement member may have a plurality of apertures formed therein, wherein the size of said apertures is less than the cross sectional dimensions of the cross sectional shape for the predetermined threshold frequency.

The plurality of apertures formed therein may be formed in an array.

Optionally, the plurality of apertures in the electromagnetic confinement member may be defined therein by photolithography.

The plurality of apertures in the electromagnetic confinement member may include at least one or more members projecting therein so as to reduce the size of the aperture and emission of electromagnetic waves therethrough.

The plurality of apertures defined in the electromagnetic confinement member may include members disposed therein, wherein the members are configured so as to reduce the aperture size and emissability of electromagnetic waves therethrough.

The electromagnetic confinement member may have a polygonal cross selection selected from the group comprising circular, elliptical, square, rectangular, pentagon, hexagon, octagon, decagon or the like.

According to another aspect of the disclosure, there is a lamp apparatus comprising: a lamp body having an input coupling element received therein, wherein one end of the input coupling element is coupled to an RF source and the other end is coupled to a first ground potential; an output coupling element received substantially within the lamp body and spaced apart from the input coupling element and from the top of the lamp body, wherein one end of the output coupling element is coupled to a second ground potential and the other end of the output at the top of the lamp body is coupled to a gas filled vessel; an electromagnetic confinement member extending from the lamp body to surround the output coupling element proximal to the gas filled vessel and including a plurality of apertures therein sized to maximise light emitted therethrough and to substantially reduce emission of electromagnetic waves which fall below a predetermined threshold frequency.

Optionally, the plurality of apertures may be defined in the electromagnetic confinement member by photolithography so as to maximise the transmissibility of light therethrough.

According to a further aspect of the disclosure, there is an electromagnetic confinement member for an electrodeless plasma lamp, wherein the electromagnetic confinement member is configured in a three dimensional shape and length and has a plurality of apertures formed therein such that upon being with engaged with a lamp body of the electrodeless plasma lamp to surround an end of an output coupling element proximal to a gas filled vessel of a plasma lamp apparatus; said confinement member reduces emission of electromagnetic waves below a predetermined threshold frequency.

### BRIEF DESCRIPTION OF THE DRAWINGS

The above and other features of the present invention, its nature and advantages will be apparent upon consideration of the following description and with reference to embodiment(s) depicted in the accompanying drawings, in which:—

FIG. 1A is a simplified perspective cross sectional view of an exemplary embodiment of a prior art electrodeless plasma lamp.

FIG. 1B is a simplified cross sectional view of the electrodeless plasma lamp of FIG. 1A.

FIG. 2A is a simplified cross sectional view of an electrodeless plasma lamp according to an aspect of the present disclosure including an exemplary embodiment of an EM confinement member affixed thereto.

FIG. 2B is a simplified cross sectional view of the electrodeless plasma lamp of FIG. 2A.

FIG. 3 depicts exemplary embodiments in which the confinement member is a mesh cage like structure having a first length.

FIG. 4 depicts a reference arrangement in which the confinement member is a solid cage like structure having a first length.

FIG. 5A depicts exemplary cross sections of the confinement member.

FIG. 5B depicts an exemplary view of a confinement member of FIG. 5A, in this case with a circular cross section.

FIG. 5C depicts apertures in a sheet from which an exemplary confinement member is formed into a desired cross sectional profiles.

FIG. 5D depicts an alternate arrangement of a sheet of FIG. 5B used to form a confinement member in which additional members extend into the middle portion of each of the apertures.

FIG. 6 is an exemplary diagram schematically depicting the photolithography process for fabricating an exemplary confinement member.

FIG. 7 is an exemplary graph depicting the flux intensity at various input powers for various configurations with and without the confinement member.

### DETAILED DESCRIPTION OF THE PREFERRED EMBODIMENTS

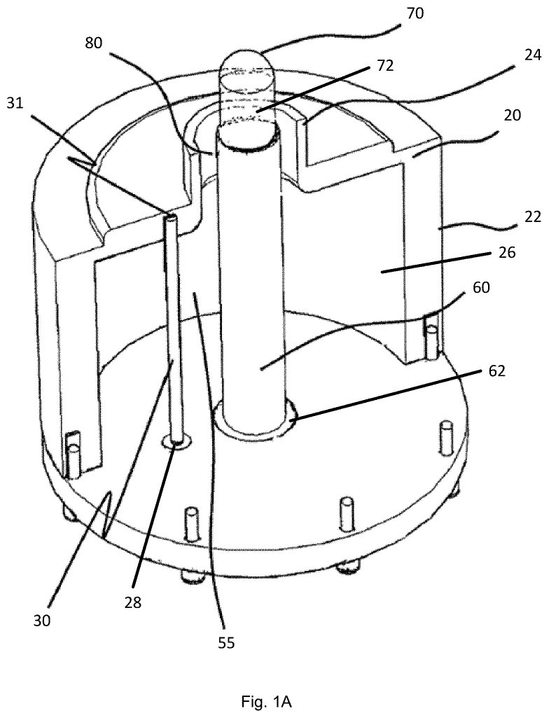

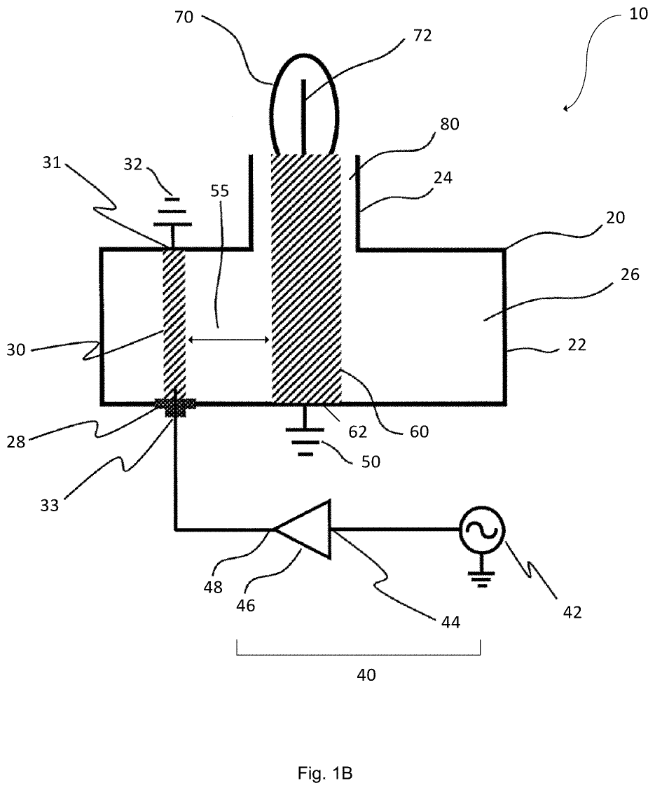

FIGS. 1A and 1B depict simplified views of an exemplary embodiment of a prior art electrodeless plasma lamp.

As depicted, the lamp 10 has a lamp body or housing 20 which has a broad bottom section 22 having a large diameter and a narrower top section 24. The lamp body is filled with air 26 or other gases such as nitrogen or fluids, or alternatively may be a vacuum. The surface of the housing is conductive; which may be either an inherent property of the material of the housing 20 or result from the application of a conductive veneer.

An input coupling element 30 is connected with the upper surface 31 of the lamp body 20 (which would be appreciated to be at ground potential 32). The other end of the input coupling element is connected to an RF connector 33 via an opening 28 in the lamp body 20. It would be appreciated that the input coupling element 30 may be solid or hollow conductor; or a dielectric material with an electrically conductive coating.

The RF source 40 comprises a oscillator 42 connected to the input 44 of an amplifier 46; which in turn is connected via the output 48 to the RF connector 33 and in turn to the input coupling element 30. It would be appreciated that the amplifier 46 may comprise multiple stages of amplification.

The input coupling element 30 therefore couples RF energy from the RF source to the output coupling element 60 with the two coupling elements being separated by a coupling gap 55.

It would be appreciated that the output coupling element 60 is connected to the lamp body 20 at the bottom 62 of the output coupling element 60; with the bottom 62 and the lamp body 20 at ground potential 50. The other end of the output coupling element 60 is connected to the bulb or gas filled vessel 70; with the plasma arc 72 contained therein. The output coupling element 60 can be made from solid or hollow electrically conductive material or alternatively can be made from a dielectric material with an electrically conductive coating. The top end of the output coupling element 60 is shaped to closely receive the bulb or gas filled vessel 70.

Where the output coupling element 60 is made from a solid conductor, it would be appreciated that a thin layer of a dielectric material or refractory metal is used as an interface barrier between the bulb and the output coupling element.

As depicted, the output coupling element 60 is spaced apart and separated from the top portion of the lamp body 20 by a gap 80. By adjusting the dimensions of the input and output coupling elements as well as the dimensions of the lamp body including the size of the gaps 55 and 80, the transfer of the RF power between the RF source and the bulb is maximized.

The gas filled vessel or bulb 70 may be made of a suitable material such as quartz or translucent alumina or other transparent or translucent material. The gas filled vessel is filled with an inert gas such as Argon or Xenon and a light emitter such as Mercury, Sodium, Dysprosium, Sulfur or a metal halide salt such as Indium Bromide, Scandium Bromide, Thallium Iodide, Holmium Bromide, Cesium Iodide or other similar materials (or it can simultaneously contain multiple light emitters).

RF energy is coupled capacitively, or inductively, or a combination of inductively and capacitively, by the output coupling-element 60 to the bulb or gas filled vessel 70, ionizing the inert gas and vaporizing the light emitter(s) resulting in intense light emitted from the lamp. The majority of the arc 72 of the bulb or gas filled vessel 70 in this embodiment is not surrounded by the walls of the lamp body; which increases the potential RF energy which is emitted into the surrounding environment.

In one example embodiment, the bottom 62 of the lamp body 20 may consist of a hollow aluminium cylinder with a 76 mm diameter and a height of 90 mm and the top portion 24 has a diameter of 20 mm and a height of 10 mm.

In this arrangement the diameter of the input coupling element 30 is about 4 cm and the diameter of the output coupling element 60 is about 10 cm. The fundamental resonant frequency of such lamp housing is approximately 433 MHz although it would be appreciated that other parameters would easily be able to be produced by a person skilled in the art.

By adjusting the various design parameters (dimensions of the lamp body, length and diameter of the output coupling element, gap between the input and output coupling element, gap between the output coupling element and the walls of the lamp body) as well as other parameters it is possible to achieve different resonant frequencies. Also it is possible by adjusting various design parameters to have numerous other design possibilities for a 433 MHz resonator.

It would be appreciated that the input coupling element 30 and the output coupling element 60 are respectively grounded at planes 32 and 50, which are coincident with the outer surface of the lamp body 20. This eliminates the need to fine-tune their depth of insertion into the lamp body—as well as any sensitivity of the RF coupling between them to that depth—simplifying lamp manufacture, as well as improving consistency in lamp brightness yield.

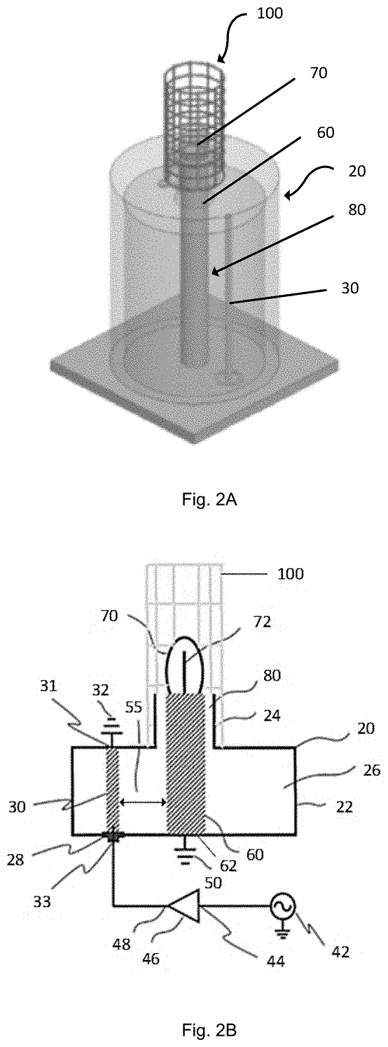

Referring now to FIG. 2A and FIG. 2B, there is a modified electrodeless plasma lamp in which an electromagnetic confinement structure 100 is included at or near to the region of the gas filled vessel (bulb) when located on the housing 20. In the embodiment depicted, the electromagnetic confinement member 100 extends in the direction of away from the housing to substantially encircle or surround the narrow upper portion of the housing. As depicted, the embodiment depicted forms a cylindrical tube spaced apart from and encircling the narrow upper portion of the housing. It would be appreciated that although in the embodiment depicted the electromagnetic confinement structure is a mesh like structure, other arrangements would also be possible without departing from the present invention.

Some electromagnetic energy emitted from the input coupling element in the direction of the output coupling element can escape from the lamp body via the gap 80; but in the embodiment depicted and according to the teachings of the present disclosure, this energy is trapped in the volume defined by the mesh like structure proximate the bulb or gas filled vessel 70 and substantially surrounding the bulb and gap such that the electromagnetic energy is not emitted therethrough.

The electromagnetic waves are trapped by the electromagnetic confinement structure and restricted from emission from the lamp body into the surrounding environment in accordance with Faraday theory. Preferably the ground potential to which the first input coupling element and the second coupling element are the same.

It would be appreciated that in other arrangements of lamp bodies, the confinement member may be located on the lamp body to surround the gap between the output coupling element and lamp body to reduce emission of energy via this gap.

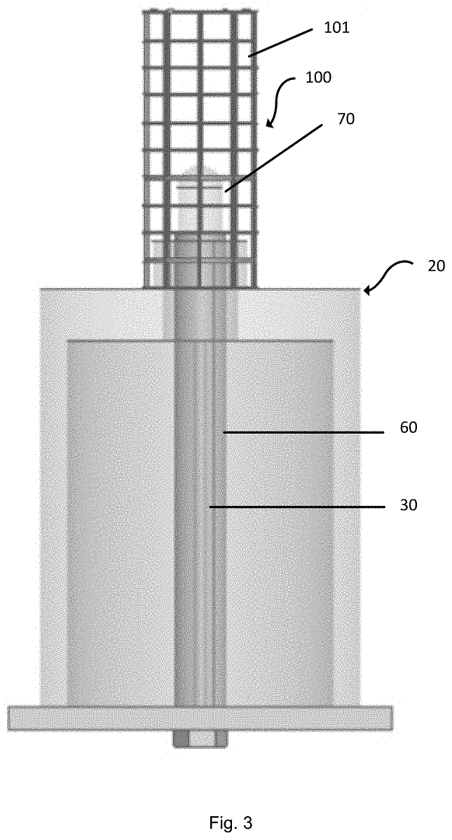

FIG. 3 is a further exemplary embodiment in which the electromagnetic confinement member 100a is a mesh cage like structure having a first length. Advantageously, the confinement member is mounted to or otherwise electrically attached to the external region of the lamp body at the potential of the lamp body.

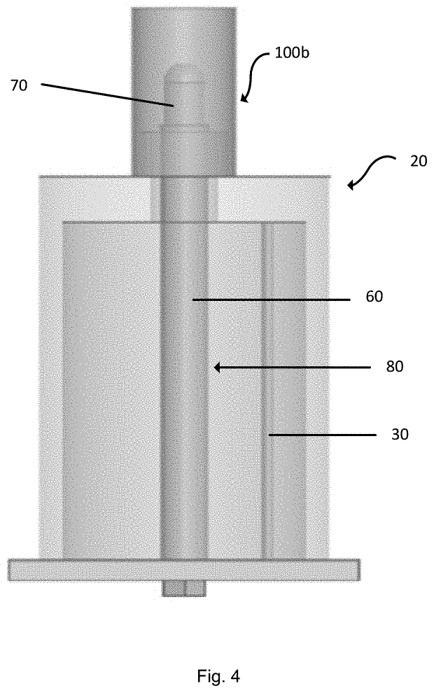

By contrast, FIG. 4 depicts an electromagnetic confinement member which provides a theoretical reference to the performance of other confinement members. It would be appreciated that the confinement member shown in FIG. 4 (being solid metal) would restrict the emission of light; unless such a confinement member has an open end. However, open ended or not, this would therefore not be an appropriate structure for a functional electrodeless lamp; causing a substantial reduction in light emission efficiency. However, it does serve as a useful reference configuration against which the operational efficiency of other arrangements of electromagnetic confinement members may be determined.

Appropriate dimensions for the electromagnetic confinement member (either mesh like structure of FIG. 3 or confinement members with other structure) may be determined according to waveguide theory. The length of the confinement member along its longitudinal axis can be determined as described below.

According to waveguide theory, frequencies above a cut off frequency can propagate through a waveguide—a transmission line in the form of a hollow metal tube—while electromagnetic waves with frequencies below the cut off frequency are trapped inside the waveguide.

According to this theory, the waveguide dimensions in cross section dictate the cut-off frequency; with different calculations depending on the specific cross section of the tube.

Where the waveguide is rectangular in cross section; the length and width of the rectangle of the cross section dictate the cut-off frequency, whilst it would be appreciated that the length of the waveguide does not affect the cut-off frequency. The cut off frequency could be calculated according to the following formula:

$${f}_{c} = \frac{c}{2 a}$$

where f_{c} is rectangular waveguide cut-off frequency in Hz; c is speed of light within the waveguide in metres per second; and a is the large internal dimension of the waveguide/confinement member in metres.

Similarly, where the waveguide cross section is circular, the cut off frequency could be calculated according to the following formula:

$${f}_{c} = \frac{1.8412 c}{2 π r}$$

where f_{c} is circular waveguide cut-off frequency in Hz; c is speed of light within the waveguide in metres per second; and r is the internal radius of the waveguide/confinement member in metres.

It would be appreciated that when the dimension of the confinement member is appropriate, the electromagnetic waves with frequencies below the cut off frequency will be trapped and will not propagate into the external environment. At the same time, light emitted from the gas filled vessel can still be emitted through the apertures 101 formed in the mesh like structure, substantially unimpeded.

In addition to the dimension of the cross section of the confinement member, the degree of attenuation is also depending on the length of the confinement member.

In order to determine an optimal length for the confinement member, the performance of the confinement member (including apertures) may be compared against empirical performance of a solid metal wall or circular waveguide without apertures as depicted in FIG. 4.

The maximum antenna gain for the tube at various different lengths can be determined, and is usually defined as the ratio of the power produced by the antenna to the power produced by a hypothetical lossless isotropic antenna. This ratio is usually expressed logarithmically, with a more negative number indicative of a better shielding performance.

TABLE 1

| Tube length (mm) | Antenna Gain (dBi) |
|---|---|
| 0 | −25 |
| 30 | −56 |
| 40 | −72 |
| 50 | −91 |
| 60 | −92 |
| 80 | −92 |

Table 1 lists the length of the solid confinement member and the corresponding antenna Gain in dBi.

Thus, for the RF antenna input power to the antenna port equal to 100 W, equivalent to 50 dBm, without using the shielding element (i.e Tube length=0), it is expected that peak radiated power would be equal to: 50 dBm-25 dB=25 dBm (which is slightly greater than ¼ W power).

By contrast, when the tube length increased to 30 cm, the antenna gain is reduced significantly, by more than 30 dB (which is equivalent to 1000 times reduction in radiated power).

It can be seen that the shielding provided by the tube at various lengths increases until it reaches a point nearly 50 mm in length. After this, there is only a limited gain despite significant increases in length (e.g. 60 mm, 80 mm are still approximately −92 dBi).

Similar measurements can be obtained for providing RF input at a predetermined level for a electrodeless lamp device according to the present disclosure as depicted in FIG. 3, with 80 mm selected as an appropriate length for −80 dBi Gain (which is determined to be similar enough for purposes of the present disclosure to be gain for an ideal reference number of −92 dBi). It would be appreciated that the length of the confinement member can therefore be selected based upon a number of considerations including the desired level of attenuation, threshold frequency, RF input and the like.

Table 2 lists the length of the mesh confinement member and the corresponding antenna Gain in dBi.

TABLE 2

| Tube length (mm) | Antenna Gain (dBi) |
|---|---|
| 0 | −25 |
| 30 | −49 |
| 40 | −56 |
| 50 | −62 |
| 60 | −69 |
| 80 | −80 |

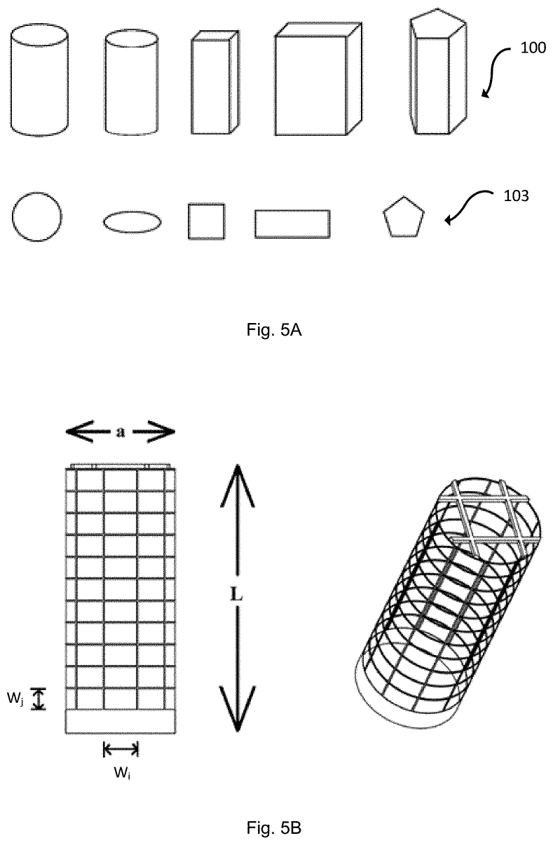

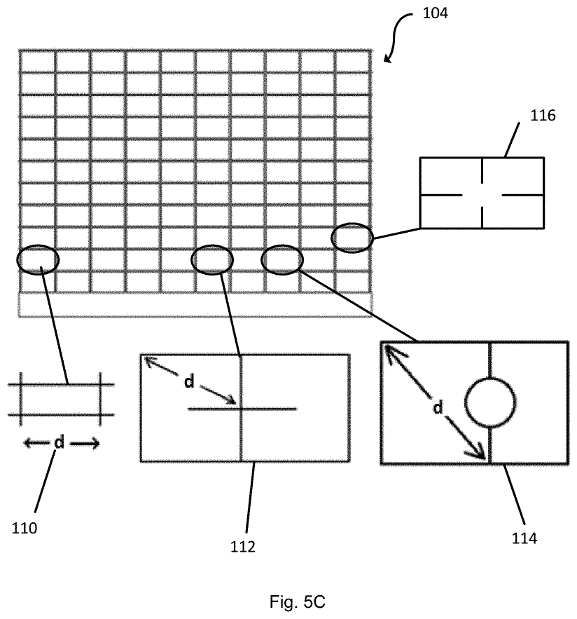

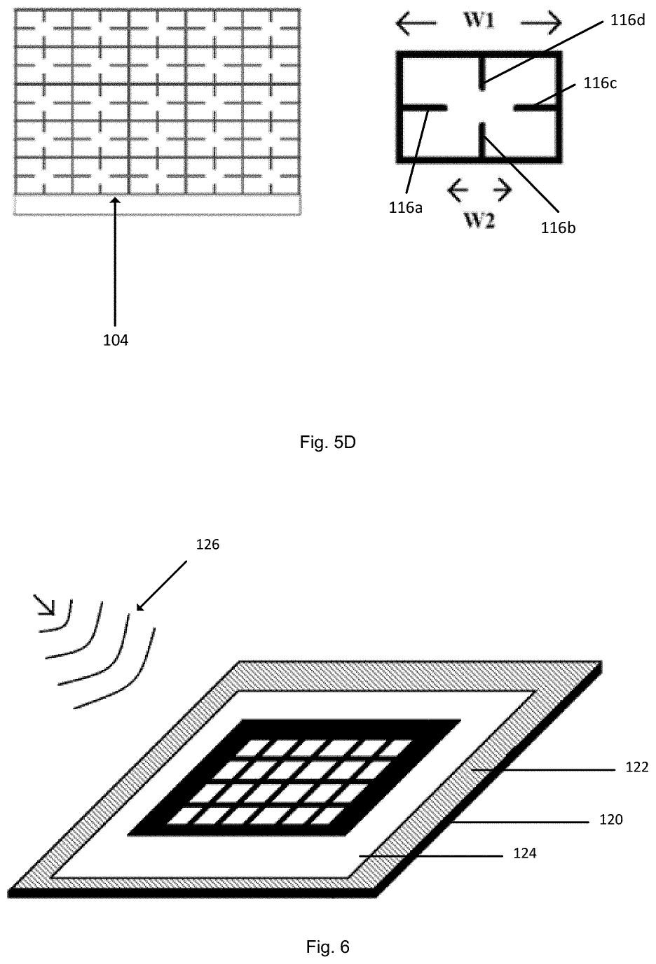

FIG. 5A is an exemplary diagram in which the cross section of the confinement member 100 is shown as having a variety of polygonal shapes in cross section 103. It would be appreciated that application of wave guide theory to determine the dimensions of the cross sections to obtain the designed suppression threshold frequency could be performed similar to that disclosed above. For ease of reference apertures in the confinement member have been omitted from the prism (polyhedrons) depicted in the diagram.

FIG. 5B depicts a mesh cage used to form a waveguide structure, in this instance having a circular cross section, although it would be appreciated that any one of the cross sections depicted in FIG. 5A could also be applicable. The dimension “a” of the diameter of the tube determines the cut-off frequency of the circular waveguide tube (the main body of the tube).

The dimension L (the length of the tube) determines the degree of attenuation for different application requirements.

The side wall of the waveguide tube is configured to include openings in repeated patterns which are made with extremely fine metal wires, to allow maximum light intensity to pass through the side wall of the cage.

In one example of the confinement member depicted, the dimension of Wi and Wj of the opening are selected to be around 30% of the size of “a”, and yet providing acceptable mechanical strength to the shape formation of the cylindrical tube.

FIG. 5C depicts alternate arrangements of apertures in a flattened sheet 104 from which an exemplary confinement member is formed into a desired cross sectional profile. The sheet has apertures, shaped and sized so that dimension marked “d” is smaller than the corresponding diameter of a circular waveguide so as to ensure that loss of electromagnetic energy is minimised. It would be appreciated that although the apertures are symmetrical, this is not mandatory; as other non-symmetrical patterns of apertures could be used provided such are selected so as to avoid allowing electromagnetic waves below a certain frequency to escape. Advantageously, the apertures in a sheet may have the same size/shape, although different arrangements of the apertures in the same sheet would also be possible as depicted by the enlarged portions shown at 110, 112, 114, 116. In particular, it should be noted that although the shape of the apertures, 110, 112 and 116 are left/right symmetrical, or rotationally symmetrical, other non-symmetrical patterns e.g. 114 may also be used provided the maximum aperture d controls the cut-off frequency to prevent emission of wavelengths through the aperture.

FIG. 5D depicts a further alternate arrangement of a sheet used to form a confinement member in which additional members 116a, 116b, 116c, 116d extend into the middle portion of each of the apertures. This arrangement maximises the size possible for the dimension of the apertures marked with w1, but at the same time minimises the region in which there is no blocking member (marked with w2), so as to reduce the potential for the electromagnetic waves to escape. This approach may be used to reduce the costs associated with production of the electromagnetic containment member.

It would be appreciated that the four members 116a, 116b, 116c, 116d provide directional suppression of electromagnetic wave leakage. A person skilled in the art would appreciate that members 116a and 116c suppress horizontal polarized component of the electromagnetic waves, whereas members 116b and 116d suppress the vertical polarization component of the waves.

FIG. 6 is an exemplary diagram in which the photolithography process for fabricating an electromagnetic confinement member is described.

Advantageously, the plurality of apertures in the electromagnetic shielding member may be produced by an electolithography process, which enables control of the dimensions and shape of the apertures, and control over the diameter of the shielding members, to approximately 0.1 mm so as to improve the light transmittance.

This maximise the suppressive effect of the confinement member, and at the same time enables maximal light transmission through the apertures. Structural integrity of this arrangement can also be maintained.

As is known in the art, photolithography is a process which uses a light sensitive photoresist which is applied to planar metallic substrate. Typically the metallic substrate is a metal sheet 120 which is highly electrical conductive formed from or coated with stainless steel, copper or similar. The photoresist 122 is applied to the metallic substrate. A masking film 124 with a desired pattern of apertures and supports is applied to the substrate and photoresist; and exposed to UV light or similar 126, followed by chemical erosion of the underlying portions of the substrate. Removal of the material from the metallic substrate is typically accomplished by etching or dissolving the metallic sheet, with only the areas protected by the masking film retaining the anti-etching ability after UV light treatment. (It would be appreciated that the inverse of this arrangement is also possible with the appropriate source of photoresist agent).

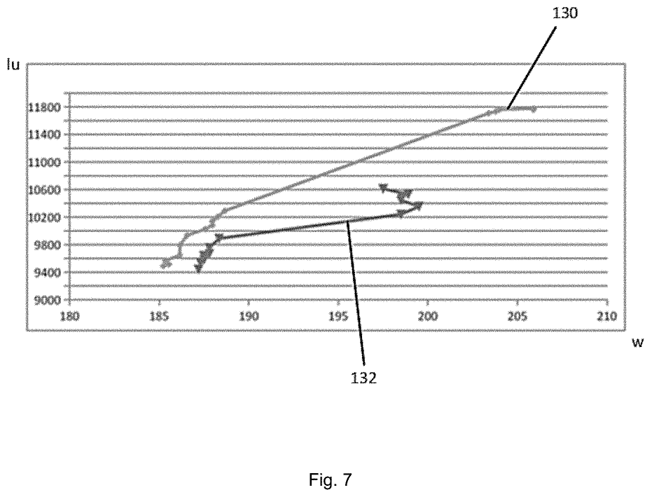

FIG. 7 is an exemplary graph depicting the flux intensity (Y axis, in Lumen) at various input powers for various configurations (X Axis, in Watts) with the electromagnetic confinement member (dotted line) and without the electromagnetic confinement member (solid line).

By comparing the performance of the luminous flux, it can be seen that under same input power, the flux intensity is increased with the presence of the electromagnetic confinement member. Conservation of energy dictates that if the residual electromagnetic energy which previously dissipated from the lamp through the aperture around the bulb is prevented from exiting at least a portion of it will be available to be consumed by the plasma arc in the bulb. Hence, notwithstanding the inclusion of the electromagnetic confinement member, the light intensity is maintained and potentially improved.

The arrangement of the electromagnetic confinement member of the present disclosure can enhances the amount of light emitted by an electrodeless plasma lamp 130 relative to the same input power for an electrodeless plasma lamp without such a confinement member 132. Furthermore, the dimensions of the cross sectional shape chosen for the electromagnetic confinement member may be selected to define an appropriate threshold frequency, such that electromagnetic waves below this threshold are attenuated as they pass down the confinement member.

Provided that the length of the electromagnetic confinement member is also appropriately selected; significant attenuation of unwanted emissions can be achieved; and at the same time output efficiency of light can be enhanced. Advantageously, the electromagnetic confinement member may include numerous apertures or holes which are formed in the member, for enabling substantially unimpeded passage of light. Where formed by photolithography processes as described; such apertures may maximise light transmissibility and at the same time maintain structural integrity, especially when the confinement member is formed as a mesh-like structure. Forming apertures in this way avoids the prior art disadvantages of woven mesh (which suffers from weak conductivity at an intersecting node) and mechanically punched mesh arrangements, which are typically left with thicker array members delineating the apertures than is the case where the mesh is formed for example by photolithographic processes.

The electromagnetic confinement member of the present disclosure provides superior performance in reducing unwanted emission of electromagnetic waves especially as compared to the performance of untethered or unconnected probes, especially which are unattached at one end.

By contrast to the inclusion of untethered or unconnected probes, or even a limited number of connected probes which are not a closed structure, the electromagnetic confinement member of the present disclosure acts a shield rather than a mere reflector. It would be appreciated by a person skilled in the art that by contrast, untethered or unconnected probes, or even a limited number of connected probes which do not define a closed structure do not shield (or very significantly reduce) the emission of electromagnetic energy, merely changing the direction of the emission.

Accordingly, wave director or reflectors usually require limited/specifically calculated position away from the source, e.g. ¼ Lambda (quarter wavelength distance). In practice, what this means for emissions in the range of 400 MHz, ¼ of this wavelength would require a probe in the range of around 17 cm from the light emission point. This would means a large bulky structure in front of the light emission point.

Furthermore, it would be appreciated that such a structure would only alter a small portion of waves (say 10%-20% of residual wave energy which is reflected back to the arc) but 80-90% of wave energy may still escape into the surroundings, because only those waves actually hitting the probe would be reflected back.

Accordingly, the present electrodeless lamp apparatus provide a more efficient and effective lighting apparatus which avoids the undesired electromagnetic wave emissions to other devices.

1. An electrodeless plasma lamp comprising:
a lamp body having an input coupling element received therein, wherein one end of the input coupling element is coupled to an RF source and the other end is coupled to a first ground potential;
an output coupling element received substantially within the lamp body and spaced apart from the input coupling element and from a top of the lamp body, wherein one end of the output coupling element is coupled to a second ground potential and the other end of the output at the top of the lamp body is coupled to a gas filled vessel;
an electromagnetic confinement member configured to extend away from the lamp body and surround the end of the output coupling element proximal to the gas filled vessel for reducing emission of electromagnetic waves below a predetermined threshold frequency therefrom, said electromagnetic confinement member including a plurality of apertures formed therein.

2. The electrodeless plasma lamp according to claim 1 wherein dimensions of the electromagnetic confinement member including at least one or more of cross sectional shape and cross sectional dimensions are configured according to the predetermined threshold frequency.

3. The electrodeless plasma lamp according to claim 1 wherein the dimensions of the electromagnetic confinement member for the predetermined threshold frequency are configured according to waveguide theory.

4. The electrodeless plasma lamp according to claim 1 wherein the distance the electromagnetic confinement member extends away from the lamp body is determined by selecting an asymptotic value of shielding performance of a plurality of distances of the confinement member of the lamp relative to a lossless ideal shielding element at the same plurality of distances.

5. The electrodeless plasma lamp according to claim 2 wherein the electromagnetic confinement member has a plurality of apertures formed therein, wherein the size of said apertures is less than the cross sectional dimensions of the cross sectional shape for the predetermined threshold frequency.

6. The electrodeless plasma lamp according to claim 1 wherein the plurality of apertures formed therein are formed in an array.

7. The electrodeless plasma lamp according to claim 6 wherein the plurality of apertures in the electromagnetic confinement member are defined therein by photolithography.

8. The electrodeless plasma lamp according to claim 6 wherein the plurality of apertures in the electromagnetic confinement member include at least one or more members projecting therein so as to reduce the size of the aperture and emission of electromagnetic waves therethrough.

9. The electrodeless plasma lamp according to claim 1 wherein the plurality of apertures defined in the electromagnetic confinement member include members disposed therein, wherein the members are configured so as to reduce the aperture size and emissability of electromagnetic waves therethrough.

10. The electrodeless plasma lamp according to claim 1 wherein the electromagnetic confinement member has a polygonal cross selection selected from the group comprising circular, elliptical, square, rectangular, pentagon, hexagon, octagon, decagon or the like.

11. A lamp apparatus comprising:
a lamp body having an input coupling element received therein, wherein one end of the input coupling element is coupled to an RF source and the other end is coupled to a first ground potential;
an output coupling element received substantially within the lamp body and spaced apart from the input coupling element and from the top of the lamp body, wherein one end of the output coupling element is coupled to a second ground potential and the other end of the output at the top of the lamp body is coupled to a gas filled vessel;
an electromagnetic confinement member extending from the lamp body to surround the output coupling element proximal to the gas filled vessel and including a plurality of apertures therein sized to maximise light emitted therethrough and to substantially reduce emission of electromagnetic waves which fall below a predetermined threshold frequency.

12. The lamp apparatus according to claim 11 wherein the plurality of apertures are defined in the electromagnetic confinement member by photolithography so as to maximise the transmissibility of light therethrough.

13. An electromagnetic confinement member for an electrodeless plasma lamp, wherein the electromagnetic confinement member is configured in a three dimensional shape and length and has a plurality of apertures formed therein such that upon being with engaged with a lamp body of the electrodeless plasma lamp to surround an end of an output coupling element proximal to a gas filled vessel of a plasma lamp apparatus; said confinement member reduces emission of electromagnetic waves below a predetermined threshold frequency.
